(19) United States
(12) Patent Application Publication
(10) Pub. No.: US 2004/0118940 A1
(43) Pub. Date: Jun. 24, 2004

(54) Hand-portable self-contained electric plant/watering-wand

(76) Inventor: Lawrence J. Lavitt, Oceanside, CA (US)

Correspondence Address: LAWRENCE J. LAVITT, 1365 VIA ISIDRO, OCEANSIDE, CA, 92056, US

(21) Appl. No.: 10/323,957

(22) Filed: Dec. 20, 2002

(51) Int. Cl. B05B 9/03

(52) U.S. Cl. 239/302

(57) ABSTRACT

A fully self-contained hand-portable watering-wand apparatus for indoor/outdoor plant-care, the EZreach-WaterWand™ assembly includes a light-weight telescopic member connected via a flex-hose, which variable-length enables user to administer plants with water (or fertilizer/herbicides/insecticide admixtures) well outward (horizontally or vertically) from one's position; and, preferably includes a triad-nozzle rotary-turret arrangement for rapid selection and dispensing of either a streaming-flow for irrigation, shower-flow spray, or mist-flow for fogging of plants. The preferably transparent liquid-canister portion includes an integral/carry-handle having an integral/filler-port, and housing a bi-directional positive-displacement type pump unit powered by an integral/battery-pack thumb-actuated via a 3-position/normally-off integral/rocker-switch; the arrangement also thereby enabling user to selectively evacuate liquid from the wand/nozzle-unit anticipating disuse.

### I.) BACKGROUND OF THE INVENTION

1. Field of Invention

This invention relates to hand-portable horticulture irrigators with electric-powered pumping means, and especially such apparatus enabling line delivery, and converse line withdrawal, of an aqueous-solution; and moreover, it relates to those types of such apparatus having self-contained energizer, and a wand like extension supporting a distal nozzle.

2. Relevant Prior-art

Background research discovery provides some prior patent-art regarded as germane to this disclosure, chronologically for example early U.S. Pat. No. 1,557,477(filed: June 1924 by P. Klinkhammer) shows an extension-pole fitted with a finger-like hood to which is dependent a terminus-nozzle to which is attached a suitable length of garden-hose which is spirally-wrapped around the entire length of the extension-pole; and thereby serves as a handy if inexpensive apparatus by which to better fight a roof-fire for example. However, there is no provision for convenient telescoping extension/contraction of the pole's length.

U.S. Pat. No. 3,837,539(filed: February 1973 via Germany) is shown a cart comprising a tubular-metal framework on wheels supporting a housing containing an electric-motor driving a compressor via a belt-drive arrangement, in combination with an abutted liquid/reservoir-tank. Hence, liquid (such as an insecticide or cleansing-solution for example) is suctioned from the reservoir-tank and passes through the compressor so as to attain a positive-pressure feeding of the liquid-substance out through a length of hose where it is fed through a tubular-wand and out a distal nozzel. Plus the apparatus provides for easy detachment removal of the compressor and replacement with an air-pump, so as to instead pass air through the wand-nozzle for convenient air-drying of wall-surfaces.

In U.S. Pat. No. 4,163,302(filed: August 1978 via Canada) is shown an industrial-vehicle fitted with a hydraulicly telescoping Boom which is also provided with lateral-rams, as to thereby enable full movement of an electric-motor driven rotary-brush member arranged at the distal end of the Boom. A coiled-hose routed abaxially parallel to the Boom, and compliantly stretches with the reach of the Boom; so at to feed a liquid-cleanser into the brush-bristles.

In U.S. Pat. No. 4,412,656(filed: April 1982) is shown a pest-exterminator's specialized multi-section telescopic-wand (8″ to 42″) having a normally-closed plunger-valve body controlled by an integral hand-lever member; having a variable-length nylon-plastic secondary liquid-delivery hose (source: Nycoil® Co. Fanwood, N.J.) coiled around said telescopic-wand, and including a conventional screw-threaded compression-fitting at its inward-end, while the outward-end of the hose is passed intimately through a longitudinal-hole provided in a support-prong extending at a right-angle down from the forward distal-end of the tele-wand, and whereto an L-shaped liquid-discharge nozzle having a tapered aftward-end is simply manually pressed into the open-end of the hose already held within the support-prong. The aftward-end of the valve-body is connected via a primary flex-hose in dedicated fluid-communication with a conventional hand-portable reservoir-bottle, of the type having a manual/piston-pump vertically disposed therein.

In U.S. Pat. No. 4,618,099(filed: July 1985 via Japan) is shown a hand-portable vegitation-plant watering/misting apparatus which comprises a molded-plastic primary-housing having a screw-on lower liquid-canister portion, above which is the primary-housing provided with an integral carry-handle portion formed as to provide a convenient cradle for snap-in receiving of a nozzle-handle member, and including a length of liquid/delivery-hose thereto which stowably coils about the primary-housing while the hose's aftward-terminus is passes through a hole in the primary-housing where it is directly pressed upon a male/tubular-outlet extending from a normally concealed relatively high-rpm electric/centrifugal-pump, powered by a battery-pack also housed within the upper/internal-cavity of said primary-housing. Thus, as compared to the immediately preceding patent, this configuration appears to enable optional substitution of a larger liquid-reservoir if desired, plus a slide-switch is built-in to the cradle, whereby returning of the nozzle-handle to the cradle acts to bias the slide-switch into an open-circuit position (defeating further pump delivery of liquid out the nozzle); nor is a check-valve included in the siphon-straw extending down into the canister, thus liquid could possibly inadvertently gravity-siphon from the nozzle were it not for the fact that the handle provides a high-point of stow-mounting which would apparently obviate siphoning occurance.

In U.S. Pat. No. 4,621,770(filed: June 1984) is shown a hand-portable vegitation-plant watering/misting apparatus (a similarly designed wheel-cart iteration is also set forth), which comprises a molded-plastic housing having an integral lower liquid-container portion, above which is provided an integral tubular carry-handle portion within which is concealed a relatively high-rpm electric/centrifugal-pump, powered by a battery-pack also housed within the upper covering of said housing. A pair of low-profile wire-conductors are spirally routed outwardly along a flex-hose attached to the outlet of the pump, thereby enabling the user to conveniently sequence miniature/solenoid-valves via finger-manipulated button-switches located within a pistol-like nozzle-unit controlling the final outletting of the container's liquid-substance through one of two differently sized nozzle-orifices. Note also, that the liquid-container portion includes a convenient protruding-lip like refilling-spout member, and the suction-staw feeding liquid therefrom into the suction-pump, also includes a check-valve at its base so as to thereby obviate possibility of liquid within the flex-hose from gravity-flowing passed the centrifugal-pump impeller and back down into the container during periods of intermittent use.

In U.S. Pat. No. 4,865,255(filed: December 1987 via Canada) is shown a cart comprising a tubular-metal framework supporting a housing containing an electric-motor directly driving a compressor, in combination with an liquid/reservoir-tank located necessarily above the pump (made so as to be readily interchangable with a reservoir containing a different liquid-substance. Hence, liquid (such as an insecticide or liquid-fertilizer solution for example) is gravity-fed from the reservoir-tank and through the thus self-priming 10,300-rpm/centrifugal-pump so as to attain a greater positive-pressure feeding of the liquid-substance out through a length of hose where it is fed through a tubular-wand and out a distal nozzel. The coaxial-handle portion of the tubular-wand includes a NO/DP(normally-open/double-pole)-switch operated by a thumb-depressed button; and so two electrical-conductors are routed along the outer-surface of the length of flex-hose delivering the liquid to the wand.

In U.K. Pat. #2,325,974(filed: August 1997 via Britain) is shown a cart comprising a tubular-metal framework supporting a housing forming a special drum like reservoir containing horticultural treating liquid-solutions such as pesticides or weedkillers, an electric-motor directly driving a liquid-pump, in combination with an liquid/reservoir-tank located substantially above the pump which is fitted into an external-cavity situated proximal the lower-side of the drum. Hence, liquid (such as an insecticide or liquid-fertilizer solution for example) is fed from the reservoir-tank and through the thus self-priming pump so as to attain a greater positive-pressure feeding of the liquid-substance out through a length of hose where it is fed through a tubular-wand (different lengths of wands are interchangeable) and out a distal nozzel. The pump-motor is activated via a DP/ST(double-pole/single-throw) switch located upon the electric-motor.

In U.S. Pat. No. 5,931,207(filed: March 1997) is shown a hand-portable home utility and garden spray-unit, comprising a liquid-solution reservior constructed in combination with an upper-housing holding a battery-powered electric-motor driving a single-piston air-compressor which exhaust-valve passageway is arranged to deliver compressed-air downwardly into the said reservoir which is female/screw-threaded upon the said upper-housing portion. A pistol-grip like DP/ST(double-pole/single-throw; unstated if momentary) switch-trigger is also formed into the upper-housing, but while spraying, operation of the tiny-compressor is believed necessarily mostly constant, as to maintain a needed head of positive/air-pressure pushing down upon the liquid within the reservior; forcing the liquid up through an improperly called “siphon”-tube (really a straw-like outlet-tube, no to siphoning involved) joined to an outlet-fitting on the upper-body of the reservoir where a length of flex-hose is attached leading to a hand-wand having a coaxial flow/control-valve in its handle portion, where a fixed-length of rigid-tubing is terminated distally with a spray-nozzle. If desired, the upper-housing may be employed apart from the reservoir, whereby a section of flex-hose may be attached directly to the compressor's outlet-port, so at to facilitate inflating of pneumatic articles such as vehicle-tires, basketball, etc.

In U.S. Pat. No. 6,094,773(filed: April 1998) is shown in relevant FIG. 7 a hand-portable combination air-compressor(118) and liquid-pump (116) unit, integrated into a single housing having an integral carry-handle positioned above a reservoir portion; and thereby enabling its user to conduct bicycle field-maintance via administering of cleaning-solvents or pressurized-air, and is equipped with a standard male/utility-plug for convenient connection to a standard automotive-type 12 v.dc. female/power-outlet.

In U.S. Pat. No. 6,209,800(filed: August 1999) is shown a watering-wand which is simply connected to a conventional garden-faucet via a standard garden-variety male/female screw-threaded hose-coupling, where is included a freely-flexible length of small-diameter (⅛th to ⅜ths-inch inside-diam) hose formed into a compactly coiled configuration whereby for example, a self-contracted 2-foot length of coiled-hose (having a constant inner/tangency-diameter said from 0.5-inch to 2.5-inches) will accommodate stretching out a distance of some 28-feet. The distal-terminus of the coiled-hose is coupled to a conventional coxial/valve-body having a fixed-length of rigid-wand extending coaxially outward therefrom, with a spray-nozzle fitted to the outermost terminus thereof. The spray-characteristic of the nozzle is said adjustable from a “heavy-stream”, a fogging-mist, or a “fan-pattern”; however, particulars of the nozzle construction achieving this spray-performance are not revealed.

Therefore, in full consideration of the preceding patent review, there is determined a need for an improved form of device to which these patents have been largely addressed. The instant inventor hereof believes their newly improved watering-wand apparatus, commercially referred to as the “EZ-REACH WATERWAND®”, currently being developed for production under auspices of the LAVITT-Mfg./Mkt.Co., exhibits certain advantages as shall be revealed in the subsequent portion of this instant disclosure.

### II.) SUMMARY OF THE INVENTION

A.) In view of the foregoing discussion about the earlier invention art, it is therefore important to make it pellucid to others interested in the art that the object of this invention is to provide an improved light-weight self-contained compact watering unit for indoor or outdoor horticultural plants and flowers; and as such, employs a novel combination of features enabling the instant invention hereof to perform advantageously over the prior-art of record. Employing an integrated liquid-pump of the substantially conventional positive-displacement bidirectional (ie: non-centrifugal reversible-flow) rotary-type having plural impeller-vanes, or more preferably of substantially conventional rotary type construction employing highly efficient dual spur-gear like intimately meshing lobes within a stationary pump-body cavity portion, wherein the pumped liquid is moved about the perimeter of the pump-body interstitially between each rotor-lobe, while the intimate meshing sector of the precisely matched lobes thus cooperates tantamount to an imperforate barrier (hence, thereby refered to as positive-displacement). Owing my preferred electric drive-motor is of the modern PM(permanent-magnet) bidirectional type, a simple conventional Momentary-DP/DT (double-pole/double-throw) rocker switch (ie: spring-biased to a center-null position) is employed; thereby enabling user to selectively depress the control-switch's rocker-paddle toward one of preferred two actuating-positions to activate the motor, which output-shaft directly turns one of the positive-displacement pump's two said rotary-lobe members (comprising an intimately engaging driven-rotor and a slave-rotor, between which is thus achieved an essentially liquid-tight barrier). The drive-motor preferably also employs an integral planetary/gear-reduction stage, enabling the drive-motor to sustain a relatively high rpm(revs.per-min.)-rate, and hence, thereby better handle hydraulic/back-pressure loading resistance imposed by function of the positive-displacement pumping action.

B.) Another object of this invention disclosure is to set forth a hand-portable self-contained horticultural irrigation unit, which is structurally embodied with a main-housing preferably comprised of an integral uppermost carry-handle portion arranged transversely there above, and preferably internally holding an electric-motor coaxially driving a liquid-pump unit; plus an control-switch is also preferably integrated therein the carry-handle, thereby facilitating an ultimately compact packaging configuration. An aftward-cavity of box like shape having an aftward-opening is preferably built-in to the back-end of the carry-handle structure for receiving a battery-pack, and also forming an aft/vertical-support rigidly joining the carry-handle to the lower-body of the primary-housing. The preferably aft-facing aftward-opening of the aftward-cavity thus preferably includes a conventional closure-panel for protection of the battery-pack during normal use, yet openable for periodic battery maintance access. A less bulky frontal/vertical-support is also preferably integrally formed to rigidly brace the forward-end of the carry-handle to the primary-housing. To facilitate better human-engineering ease of operation, an approximate 45-degree chamfer surface is preferably provided at the upper/forward-end of the carry-handle, thereby positioning the preferred rocker-type electric control-switch (switch's rocker may include a paddle like extension) for easy thumb-activation, although certainly, the control-switch can alternately be of the momentary (center-null) sliding-tab type.

So as to obviate necessity of user having to manually remove the liquid-reservoir canister during refills, it is preferred that a convenient integral pouring-aperture (preferably replete with integrally-molded grid-like strainer and flip-lid closure) be cast into one of the two preferably injection-molded right-side & left-side mating half-shell portions of the main-housing. Additionally, it is preferred that the left-side and right-side of the main-housing be optionally formed as to captively hold a central separately-molded screw-cap like non-rotating third-member, into which in turn would be provided the female/screw-threading thereunder (which can alternately, be molded directly into the said respective right-side and left-side portions of the main-housing). In either case, the central preferably female/screw-threading serves to receive manual screw-on attachment of a canister type reservoir, thus having a mating male screw-threaded uppermost collar. To thus communicate the liquid-pump's inlet-port with the reservoir contents beneath, a preferably simple flexile inlet-tuble member extends down proximal the internal bottom of the reservoir.

The preferred laterally split (right-half/left-half) main-housing construction also facilitates convenient production-line assemblage of sub-components, whereby are incorporated within the injection-mold/tooling-dies, suitably shaped declivities in the form of cavity/support-abutments discretely shaped as to thereby captively if intimately hold components such as the electrical/mode-switch, drive-motor, and liquid-pump; as well as any small preferably stainless-steel (ie- corrosion-resistent) contacts affording battery-continunity (although alternately here, a standard commercially-available battery-receiver pack can suffice with its two (pos./neg.) power-leads extending to the control-switch and drive-motor.

C.) Another object of this invention disclosure is to set forth a hand-portable self-contained horticultural irrigation unit according to my preceding items-A/B, wherein is also provided in combination a convenient handheld tubular-wand constructed of finitely slidable telescopic-sections which are manually retractable for irrigation of closely located horticulture; or conversely, the tubular-wand may be conversely readily extended for access to otherwise difficult to reach horticulture. Note the preceding term “irrigation” is employed herein as to broadly reference any of the selectable liquid deliveries involving an outward flow of a generally water based substance. For example, dependent upon ones manual adjustment of the substantially conventional preferably variable-orifice delivery-manual adjustment of the substantially conventional preferably variable-orifice delivery-nozzle, a preferred choice of irrigational outflows ranging from a streaming-spray (when delivery-nozzle's rotary-barrel is longitudinally lengthened or extended), into a sprinkling-spray (when rotary-barrel is medially positioned), then progressively a fogging-spray (when rotary-barrel is rotatively longitudinally shortened or contracted) is also provided. Although the delivery-nozzle could thus be constructed to operate throughout these stated progressions on a pure linear manner (relative to the longitudinal-axis of the nozzle), it has been found that the rotary design is the most practical, owing that it's worm/screw-threading construction enables more venier-like fine transitions which inherently stay in any particular setting.

In order to facilitate ease of accessing horticulture at various reaches (both as to azimuth and elevation orientation), and yet be suitable for irrigating nearby plants, plus being compact for easy stowing, the tubular-wand (made hollow for lightness and rigidity) is preferably made extendable, preferably via telescopic means; whereby at least one diametrically-smaller hence inner-fitting telescopic-section is capable of being manually retracted within the distal end of the main tubular-wand portion. The inward-end of the tubular-wand is preferably only about 4½-feet in length including a preferably coaxial handgrip portion, and thus just a single extendibly sliding or telescoping concentric-tube portion facilitates a full-extension to almost 9-feet. Moreover, it is preferred the main tubular-wand portion be made of anodized-aluminum owing to it's relative rigidity, while the outwardly sliding concentric-tube portion is preferably made of an extruded-plastic (such as common PVC) owing to its light-weight durability; and whereby the coefficient-of-friction thus prevailing between the two very dissimilar tubular materials is such that the inner telescopic-tube member is conveniently maintained in any finitely selected extension simply by means of the Inherent interacting friction (slight drag) capable of maintaining a fixed telescopic setting (sufficient to resist the pull-of-gravity) although the tubular-wand be held at a vertical elevation attitude. Accordingly a generic-variant of this telescopic construction would be to include an internally or externally acting slip-ring, exhibiting sufficient compliance as to enable easy manual sliding of the telescopic member, yet in any case capable of maintaining the selected extension setting in the full vertical attitude of overhead use; as when accessing high hanging horticultural-plants.

### III.) DESCRIPTION OF THE PREFERRED EMBODIMENT DRAWINGS

The foregoing and still other objects of this invention will become fully apparent, along with various advantages and features of novelty residing in the present embodiments, from study of the following description of the variant generic species embodiments and study of the ensuing description of these embodiments. Wherein indicia of reference are shown to match related matter stated in the text, as well as the Claims section annexed hereto; and accordingly, a better understanding of the invention and the variant uses is intended, by reference to the drawings, which are considered as primarily exemplary and not to be therefore construed as restrictive in nature; wherein:

FIG. 1, is a pictorial perspective-view, favoring the frontal upper-right portion of a person employing my exemplified invention, demonstrating how it can be deployed to its most upwardly extended modality of usage;

FIG. 2, is an upper left frontal oblique view of my hand-portable integrated pump and reservoir unit, which is shown vertically partially exploded as to better reveal certain features of its construction;

FIG. 3, is a medial cross-sectional view of an exemplified positive-displacement liquid pump unit, substantially of the type which I prefer be employed within the carry-handle of my invention;

FIG. 4, is a rudimentary electrical-circuit schematic diagram, of the type preferably be incorporated within my invention;

FIG. 5, is a partial cut-away left/side-elevation view showing the preferred embodiment of my hand-portable liquid pumping and reservoir unit employed in my invention;

FIG. 6, is a longitudinal left-side cross-sectional view showing an exemplified embodiment of my preferred spray-nozzle apparatus;

FIG. 7, is an upper-left oblique-view showing the exterior of the variable spray-nozzle and associated feeder-hose, as set forth in preceding FIG. 6.

### IV.) Itemized Nonenclature References

10,10′/10″,10G— demonstration person, demo person's hands: left/right, ground surface

11,11′,11″— environmental plant, plant-holder, hanger-cords

12,12′— overall irrigation-unit, vertical ref.-axis

13L/13R,13S— main-housing half-shells: left-side/right-side, joint-seam split-line

14,14L/14R,14′/14″— carry-handle, left-side/right-side, vertical supports: front/rear

15L/15R,15,15′,15″— battery-box: left-side/right-side, cavity, closure-panel, bat.-pack

16L/16R,16— annular-receiver: left-half/right-half, retention-cavity (typical)

17,17′,17″— refill-aperture, pouring-action, contained liquid

18,18T,18′/18″,18S— central-body, top, retention-tabs: left/right, female/screw-threads

19,19′,19″,19S— overall canister, chime, inside-bottom, male/screw-threads

20,20′/20″,20D— bayonet-mt: annulas, engager-pin/engager-slot, slot-detent

21,21′— bidirectional/drive-motor, axis-of-rotation

22,22′,22″,22A— DP/DT-switch, switch-actuator, support-flange, support-abutment

23/23′/23″— operational modes: null-mode/inflow-mode/outflow-mode

24/24′/24″— elect.-circuits: primary/reverse/forward

25/25′25″— elect.terminal references: battery/switch/motor

26,26′,26″,26M,26A,26L— Pos.disp. pump-housing, inlet, outlet, impeller, rotary-axis, liquid

27′/27″— fluidic-canal: out-flow ref.-arrow/in-flow ref.-arrow

28,28′— inlet-tuble, outlet-tuble

29,29′,29″— outlet-fitting, support-flange, support abutment

30,30C,30′/30″— flexile-conduit, compliance coiling, inward-end/outward-end

31,31′/31″,31E— tubular-wand, fixed-section/tele.-section, distal-end

32,32′,32″,32T,32A— handgrip, longitudinal-axis, pivot-head, pivot-trunion, pivot-axis

33,33′,33″,33B,33F— deliv.-nozzle, vari.-orifice, control-barrel, through-bore, nozzle-fitting

34,34′/34″,34B— distal-mount, variable tele.-action: extension/retraction, slide-bushing

35,35′— assembly-screws, loop-bands

36,36′— control-barrel travel-range, irrigation-output (stream, or spray, or mist)

### IV.) DETAILED DESCRIPTION OF THE PREFERRED EMBODIMENTS

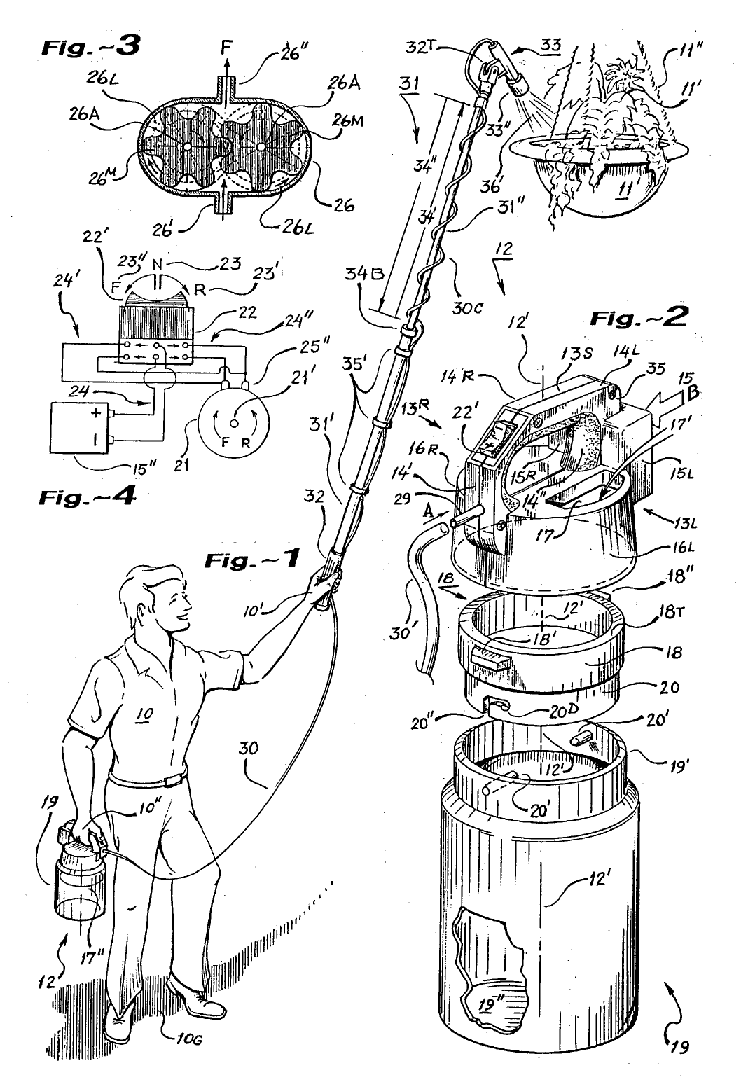

Initial reference is given by way of FIG. 1, wherein is exhibited a person 10 demonstrating my invention, wherein his right-hand 10″ grasps the carry-handle 14 portion of the overall irrigation-unit 12 having a canister 19 portion generally containing a horticulturely suitable liquid, which is conveyed to a right-hand 10′ held (by handgrip 32) tubular-wand 31 via flexile-conduit 30; thereby conveniently irrigating 36 the otherwise difficult to assess exemplified ceiling-hanging environment plant 11 via delivery-nozzle 33. It will be noted that the flexile-conduit 30 can be an ordinary length of transparent vinyl-tubing (generally having an inside-diameter of about 5/32″-id) which is merely incrementally secured to the fixed-section 31′ portion of the tubular-wand via loop-bands 35′; but so as to accommodate the variable tele.-extension 34′ or retraction 34″ of the cooperative telescopic-section 31″, the conduit is compliantly coiled 30 about that concentric portion of the tubular-wand (thus compactly gathering retracted proximal the medial slide-bushing at distal-end of fixed-section 31′).

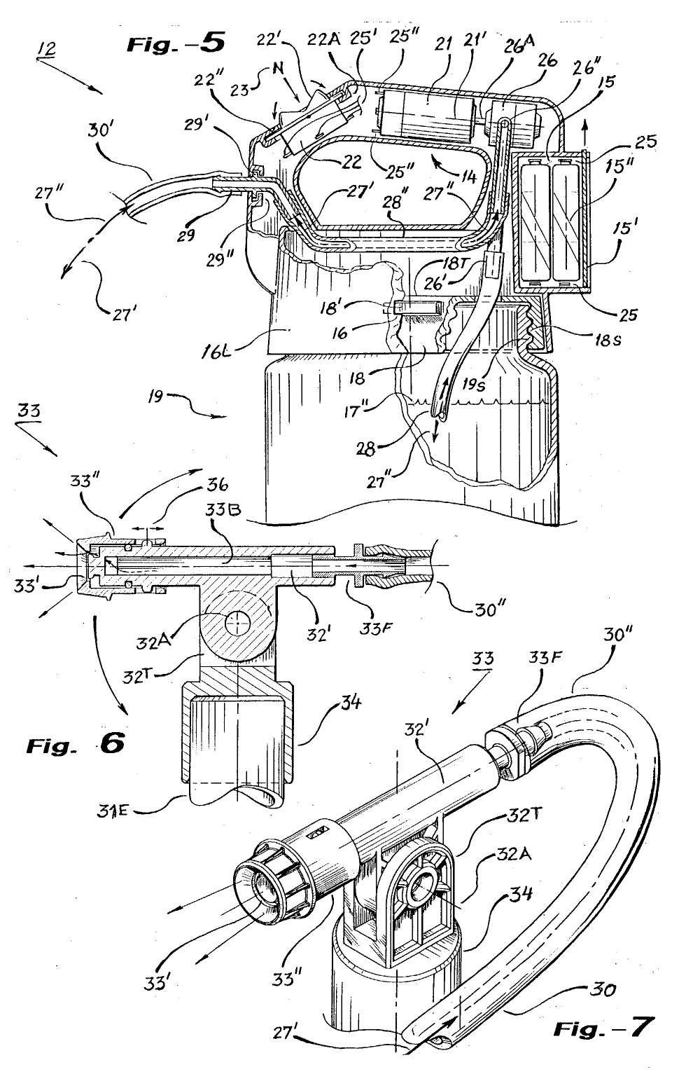

There remain however, vital other features which are to become herein more evident and understood as important improvements. For example, FIG. 2 shows an example of how the overall irrigation-unit 12 is presently preferably constructed with an upper main-housing comprised of two mirror-image opposed portions, identified as the right-side 13R and the left-side 13L (delineated by divisional joint-seam split-line 13S), which are assembled together at the factory via self-threading assembly-screws 35. Accordingly, held captive between these two half-shells is a so called central-body member 18 having laterally opposed retention-tabs 18′ and 18″, which are received into mating retention-cacities 16 molded into the main-housing half-shells (ref. FIG. 5). This particular main-housing embodiment while configured for high-volume injection-molding manfacture, is set forth herein to further convey how my invention can be designed for ease of production-line assembly; whereby the various components readily fit into preformed receiving cavities, obviating need for subassembly fasteners. For example, also note by referencing between FIG. 2 and FIG. 5, how the preferred rocker-switch's 22 existing end support-flanges 22″ are held captive into intimately formed support-abutments 22A, and adjacent outlet-fitting 29 radial support-flange 29′ is likewise received into intimately form-fitting support-abutment portions 29″; enabling user to vigorously push-on or pull-off inward-end 30′ of the flexile-conduit relative to the externally accessible portion of the outlet-fitting 29. Here also in FIG. 5 is shown how the bidirectional/drive-motor 21 and its axially 26A driven pump 26 are preferably housed neatly within the hollow handgrip or carry-handle 14 confines, whereby associated electrical-terminals 25″ and their respective conductors 25′ cooperating with battery-compartment cavity 15 elect.-terminals (including associated contact formations) 25, are all protected within the described dielectric-plastic main-housing half-shells. Note also, how the preferred conventional rocker-switch 22 is set upon a well human-engineered angle, facilitation convenient left or right hand thumb operation.

The desirably underslung (primarily for balance purposes) liquid-reservoir canister 19 having vertical-axis of reference 12′, is shown in FIG. 2 as having a type of bayonet-mounting, employing opposed engager-pins 20′ which index up into semi-circular engager-slots 20″ provided beneath the main-housing (here shown formed into optional central-body 18). In FIG. 5 however, I show canister 19 now installed, replete with exemplified horiticultural liquid 17″; and note that it is here configured as a generic-variant embodiment, with a fully male/screw-threaded 19S chime, received into female/screw-threads 18S provided within the captive central-body 18. A further alternate embodiment (not shown) can be to have a reservoir canister 19 preferably removably secured to the main-housing via toggle-clamps for example; the main point here, being to provide the user some convenient way of removing the canister, thereby enabling quick and easy switching between different liquid solutions (as described earlier in this disclosure).

In FIG. 3 is shown an exemplified embodiment of a necessary conventional pos.-displacement type liquid-pump 26, having an inlet 26′ fitting, and an outlet 26″ fitting, in fluid-tight communication therein; whereby the bidirectional/drive-motor 21 (see FIG. 5) is axially connected to either of the two rotary-axles 26A as to thereby simultaneously rotate both starwheel like meshing impellers 26M, and thus positively move liquid within the interstitutal spaces 26L either F/foward out outlet 26″ or R/reversibly out the so called inlet 26′. Hence, the bidirectional quality of the FIG. 3 liquid-pump, is controlled by which ever modality of operation is selected by user's 10 discrete manipulation of the switch-actuator 21′ in FIGS. 2 & 5; as is further explained via FIG. 4. Exhibited in FIG. 4 is the preferred rudimentary electrical schematic-diagram utilizing a conventional three-modal electrical-switch 22 (of momentary/center-null: double-pole/double-throw configuration) capable of effectively flip-flopping the two discrete electrical-circuits 24′ and 24″, as to thereby reverse the polarity relationship of battery 15″ (Note: energizing-source can also be regular line-current such as 115 v.ac, however it is desired to liberate user from restrictive presence of associated electrical-cord). Although ordinary alkaline-type drycell-batteries are found adaquate to the task, more professional-use heavy-duty embodiments of my invention can be adapted with the convenient plug-in interchangeable type of rechargable-battery (generally 7.2 v.-18.0 v.dc) such as employed by hand-portable electric-tool manufacturer Ryobi(Ryobi-Technologies, 1428 Pearlman Dairy Rd., Anderson, S.C. 29625). Therefore, the battery-compartment 15 shown with closeble sliding closure-panel 15′ in FIG. 5, is merely exemplary of a working apparatus only, and not necessarily representative of a production article (which battery may be of the popular plug-in type design).

In the user released (self-canceling) N/null-position, the liquid visible within the preferably transparent flexile-conduit 30 can be observed by the user to remain stationary, but depressing the preferred rocker/switch-actuator to (+)position (or other equivalent symbol) shown in FIG. 2 activates the motor 21 to resultantly rotate impellers 26A and thus draw liquid 17″ from the canister 19 confines, up via inlet-tuble 28, through the liquid-pump 26 wherein the liquid becomes identified as 26L and out via port 26″, then through optional intermediate fluid-conduit 28″ via inside portion of outlet-fitting 29 as indicated in FIG. 5, where the liquid is driven through flexile-conduit 30 through the distal outward-end 30″, through provisional nozzle-fitting 33F, and into through-bore 33B of delivery-nozzle 33, where it is ultimately released out from the optional 33″ control-barrel's preferred variable-orifice 33′ (reference action-arrows are shown the delivery-nozzle to aid visualizing of liquid flow therein). Conversely, when user is completed with their procedure of plant-watering, or may otherwise wish to change to a different administering liquid, they merely bias into switch-actuator 22′ (−)position, as to thus R/reverse the flow of liquid remaining within the system (from the most distal nozzle-orifice 33′ ) all back into reservoir canister 19 via the so called inlet and inlet-tuble 28; thereby fully purging the fluidic-canal of the immediate liquid solution, so as to subsequently introduce the different liquid substance. As was mentioned earlier, this novel purging capability enables the user to even flush the just described fluidic-canal (ie: the entire contiguous imperforate-passageway from the inlet proximal the region 19″ of the inlet-tuble 28 to the distal orifice 33″) free of any potentially damaging herbicide/liquid-solution via fresh plain water, prior to reintroducing a nourishing liquid plant-food for example. Additionally, the flushing procedure is recommended whenever the irrigation-unit 12 is expected to be sitting unused for an extended period of time; thereby precluding any possible clogging-up by thickening of certain types of liquid-solutions therein.

As revealed in FIGS. 6 & 7, the preferred delivery-nozzle aggregation is preferably adapted to distal-end 31E of the tubular-wand 31″ via a fixedly pressed-on female nozzle-mount 34, where an alternate internally adapted male-mount (not shown) would suffice as well; and which abuts the wand's slide-bushing 34B when the variable tele.-section is manually fully retracted. While various sorts of known tele.-locking devices (ie: twist to lock) could be adapted, presently it is preferred that the tele.-action extension position be maintained simply via the natural frictional sliding-fit of the respective fixed 31′ and telescopic 31″ sections as is aided by presence of annular slide-bushing 34B. With the tubular-wand assembly 31 held in a perpendicular attitude to the ground 10G, the orientation of the supported delivery-nozzle is adjusted in azimuth by merely turning the assembly 31, while elevation of the delivery-nozzle is preferably manually tilted to the desired angle when the nozzle is momentarily brought down to within reach by hand. The pivot-trunion 32T includes a pivot-axis 32A, which are preferably assembled via a tubular-rivet (not clearly shown), which thereby preloads a sufficient amount of pivotal-friction as to maintain the delivery-nozzle 33 at any desired degree of pitch, ranging between the steeply pitched extremes suggested via the outlaying action-arrows; conveniently enabling the delivery-nozzle's longitudinal-axis 32′ to be aimed steeply-down or aimed steeply-up. The aimed-down delivery-nozzle attitude is found to be particularly useful in such instances where it is desired to overlook the blind-edge of a planter, as has been exhibited in FIG. 1. Although a simplified linear-sliding control-barrel 33″ is exemplified here for illustrative clarity, it is preferred that the control-barrel be of the conventional rapid screw-thread rotary-action type long known to provide more precise control over the manual selection of the desired “stream, spray, and mist” flow option. The linear-travel range 36 indicated in FIG. 6 is thus tantamount to that provided by the rotary-action iteration not actually shown here.

Thus, it is readily understood how the preferred and generic-variant embodiments of this invention contemplate performing functions in a novel way not heretofore available nor realized. It is implicit that the utility of the foregoing adaptations of this invention are not necessarily dependent upon any prevailing invention patent; and, while the present invention has been well described hereinbefore by way of certain illustrated embodiments, it is to be expected that various changes, alterations, rearrangements, and obvious modifications may be resorted to by those skilled in the art to which it relates, without substantially departing from the implied spirit and scope of the instant invention. Therefore, the invention has been disclosed herein by way of example, and not as imposed limitation, while the appended Claims set out the scope of the invention sought, and are to be construed as broadly as the terminology therein employed permits, reckoning that the invention verily comprehends every use of which it is susceptible. Accordingly, the embodiments of the invention in which an exclusive property or proprietary privilege is claimed, are defined as follows.

VI.) What is claimed of proprietary inventive origin is:

1.) A hand-portable self-contained horticulture irrigation unit; said apparatus comprising:
a main-housing having an integrated mode-switching means controlling electrical-current of an integral battery-pack powering an integral bidirectional/drive-motor turning an integral positive-displacement reversible-flow liquid-pump having an inlet-tuble extending down proximal internal bottom of a reservoir means located thereunder;
a length of flexile-conduit with inward-end arranged in fluid-tight communication to outlet-port of said liquid-pump, while distal-end of said flexile-conduit is in fluid-tight communication with a delivery-nozzle means arranged at distal-end of a tubular-wand means including a handgrip means arranged at the inward-end thereto;
a instant user selection of three discrete electrically switched operational modalities is provided identified as: null-mode, outflow-mode, inflow-mode, thereby giving user full command over position of liquid throughout the fluidic-canal.

2.) The hand-portable irrigation apparatus according to claim-1, wherein said mode-switching means is a conventional momentary-DP/DT type electric-switch, wherein center-position is “null”, forward-position activates positive outward flow of liquid, aftward-position activates positive inward flow of liquid.

3.) The hand-portable irrigation apparatus according to claim-1, wherein said reversible-flow liquid-pump is of conventional non-centrifugal positive-displacement type having constant essentially liquid-tight intimate-contact within the pump-housing confines.

4.) The hand-portable irrigation apparatus according to claim-1, wherein said reservoir is a canister having a screw-threaded uppermost collar, enabling quick and easy manual attachment or removal relative to mating screw-threads provided beneath said main-housing.

5.) The hand-portable irrigation apparatus according to claim-1, wherein said main-housing is constructed in three primary sections: comprising a central-body held permanently captive by two laterally converging left-side and right-side half-shell portions forming exterior of said main-housing; said central-body including female/screw-threading thereunder serving to receive mating male/screw-threads of said reservoir, plus an integral refill-aperture is provided in one of said half-shell portions serving to facilitate convenient replenishing of liquid into said reservoir without having to temporarily detach said reservoir.

6.) The hand-portable irrigation apparatus according to claim-1, wherein said main-housing is constructed in three primary sections: comprising a central-body held permanently captive by two laterally converging left-side and right-side half-shell portions forming the exterior of said main-housing; said half-shell portions together forming an integral carry-handle portion which is thus likewise formed of a left-side and a right-side including integral cavity support-abutments discretely formed as to captively hold said electrical/mode-switch and said drive-motor and said liquid-pump and said battery-pack for convenient production-line assembly.

7.) The hand-portable irrigation apparatus according to claim-1, wherein said main-housing is comprised of two opposed left and right half-shell portions which become essentially permanently joined together forming walls of an aftward battery-box wherein is located said battery-pack, and including an aftward-opening thereto facilitating access therein for convenient periodic battery maintance; said aftward-opening normally including a closure-panel for protection of said battery-pack.

8.) The hand-portable irrigation apparatus according to claim-1, wherein said tubular-wand means is constructed of finitely slidable telescopic sections which are manually retractable for irrigation of closely located horticulture, or manually extendable for otherwise difficult to reach horticulture; and whereby said flexile-conduit portion thereto is compliantly coiled around said tubular-wand as to thereby cooperatively expand/contract respectively upon extension/retraction of said tubular-wand.

9.) The hand-portable irrigation apparatus according to claim-8, wherein said tubular-wand is approximately 4½-feet long fully retracted, and approximately 9-feet long overall fully extended.

10.) The hand-portable irrigation apparatus according to claim-1, wherein said delivery-nozzle means includes a pivot-head affoxed to said tubular-wand distal-end and includes a transverse pivot-trunnion arrangement; thereby enabling said pivot-head's delivery-nozzle member to be manually pitched to such variable angle relative to longitudinal-axis of said tubular-wand as may be found preferable by user for best directing flow from said delivery-nozzle for accommodating different accessibilities.

11.) The hand-portable irrigation apparatus according to claim-1, wherein said delivery-nozzle means includes a male inlet-fitting for receiving said flexile-conduit's outward-end, said delivery-nozzle employing a conventional manually adjustable control-barrel providing a variable-orifice means, whereby horticulture irrigation is facilitated ranging from an streaming-spray when said control-barrel is longitudinally lengthened, and then into a sprinkling-spray as said control-barrel longitudinal position is medially shortened, then into a fogging-spray when said control-barrel is rotatively longitudinally shortened.

12.) A hand-portable self-contained horticulture irrigation unit; said apparatus comprising:
a main-housing having an uppermost carry-handle and integrated thereto a conventional momentary-DP/DT type electric-switch wherein center-position is “null”, forward-position activates positive forward-flow of liquid, and aftward-position activates positive reverse-flow of liquid, by controlling electrical-current of a battery-pack powering a reversible drive-motor turning a reversible-flow liquid-pump of conventional positive-displacement rotary type which vanes are in intimate-contact within pump-housing confines having an inlet-tubule thereto which lower-terminus extends down proximal inside-bottom of a reservoir means located thereunder;
a length of flexile-conduit its inward-end arranged in fluid-tight communication with output-port of said liquid-pump, while its outward-end is in fluid-tight communication with a delivery-nozzle arranged at the distal-end of a tubular-wand having a handgrip arranged at its inward-end and including at least one diametrically-smaller telescopic-section which manually retracts for irrigation of closely located horticulture, or will finitely extend for accessing more distant horticulture, said flexile-conduit portion thereto being compliantly coiled around said tubular-wand as to thereby cooperatively expand/contract respectively upon extension/retraction of said tubular-wand;
a instant user selection of three discrete operational modalities is thus provided user, enabling full command over position of liquid throughout the fluidic-canal, and said outflow-mode activates flow of liquid out of said delivery-nozzle, and inflow-mode returns liquid remaining within said fluidic-canal back toward said reservoir.

13.) The hand-portable irrigation apparatus according to claim-12, wherein said reservoir is a canister having a screw-threaded uppermost collar, enabling convenient manual attachment/detachment relative to mating screw-threads provided beneath said main-housing; bottom of said canister including a central knob like downward protrusion.

14.) The hand-portable irrigation apparatus according to claim-12, wherein said main-housing is constructed in three primary sections: comprising a central-body held permanently captive by two laterally mating left and right side portions forming the exterior of said main-housing; said central-body including female/screw-threading thereunder serving to receive mating male/screw-threads of said reservoir, plus an integral pouring-aperture is provided in one of said half-shell portions as to thereby facilitate convenient replenishing of liquid into said reservoir without detaching said reservoir.

15.) The hand-portable irrigation apparatus according to claim-12, wherein said main-housing is constructed in three primary sections: comprising a central-body held permanently captive by two laterally converging left-side and right-side half-shell portions forming the exterior of said main-housing; said half-shell portions together forming an integral carry-handle portion which is thus likewise formed of a left-side and a right-side including integral cavity/support-abutments discretely formed as to captively hold said electrical/mode-switch and said drive-motor and said liquid-pump and said battery-pack for convenient production-line assembly.

16.) The hand-portable irrigation apparatus according to claim-12, wherein said main-housing is comprised of two opposed left and right half-shell portions which become essentially permanently joined together forming an aftward-cavity of box like shape into which is located said battery-pack, and including an aftward-opening thereto facilitating access therein for convenient periodic battery maintance; said aftward-opening normally including a closure-panel for protection of said battery-pack.

17.) The hand-portable irrigation apparatus according to claim-12, wherein said delivery-nozzle means includes a mounting-head which is pivotally attached to said tubular-wand distal-end via an L-shaped pivot-bracket arrangement; thereby enabling said mounting-head to be selectively pitched to a variable-angle relative to longitudinal-axis of said tubular-wand as may be found preferable by user.

18.) The hand-portable irrigation apparatus according to claim-12, wherein said delivery-nozzle means includes a male/inlet-fitting for receiving said flexile-conduit's distal-end, the nozzle employing a conventional manually adjustable control-barrel providing a variable-orifice means, whereby plant irrigation is facilitated ranging from an streaming-spray when said control-barrel is ultimately lengthened, and a sprinkling-spray as said control-barrel longitudinal position is medially shortened, and then a fogging-spray when said control-barrel is rotatively ultimately shortened.

19.) A hand-portable self-contained horticulture irrigation unit; said apparatus comprising:
a main-housing having an uppermost carry-handle and integrated thereto an electrical/mode-switch means controlling electrical-current of a battery-pack powering a PM/drive-motor turning a positive-displacement reversible/rotary-vane liquid-pump having an inlet-tubule which lower terminus is arranged proximal inside-bottom of a reservoir having screw-threaded means of attachment to said housing;
a length of flexile-conduit its inward-end arranged in fluid-tight communication with output-port of said liquid-pump, while outward-end of said flexile-conduit is in fluid-tight communication with the male/inlet-fitting of a conventional rotatively axially-adjustable delivery-nozzle means of progressively selecting a streaming-spray or sprinkling-spray or fogging-spray, said delivery-nozzle including a an attitude-adjustment spray-axis aiming-means at distal-end of a telescopicly-adjustable tubular-wand having a handgrip arranged at its inward-end;
a instant user selection of three discrete electrically switched operational modalities is provided identified as: null-mode, delivery-mode, evacuate-mode, giving user full command over position of liquid throughout the fluidic-canal, and thereby enabling user to conveniently activate flow of liquid outward of said nozzle, then negate the flow, then return liquid flow remaining within said delivery-nozzle back toward said reservoir, thereby obviating undesirable dripping of liquid from said delivery-nozzle and enabling purging all liquid from the fluidic-canal for discretely changing to an alternate reservoir containing a different liquid ingredient, thus obviating problematical cross-contamination of reservoir ingredients or for cleanly evacuating the fluidic-canal for purpose of stowing.

20.) The hand-portable irrigation apparatus according to claim-19, wherein said electrical/mode-switch means is of the momentary-DP/DT type.
